(19) United States
(12) Patent Application Publication
(10) Pub. No.: US 2008/0066109 A1
(43) Pub. Date: Mar. 13, 2008

(54) VEHICLE VIDEO DISPLAY SYSTEM

(75) Inventors: Katherine A. Dunning, Austin, TX (US); Michael A. Paolini, Austin, TX (US); Cristi N. Ullmann, Austin, TX (US)

Correspondence Address: CANTOR COLBURN LLP - IBM AUSTIN, 20 Church Street, 22nd Floor, Hartford, CT, 06103, US

(73) Assignee: International Business Machines Corporation, Armonk, NY (US)

(21) Appl. No.: 11/470,653

(22) Filed: Sep. 7, 2006

(51) Int. Cl. H04N 7/00

(52) U.S. Cl. 725/48; 725/75

(57) ABSTRACT

A video display system for use in a vehicle, includes a display disposed in a vehicle for viewing by an operator of the vehicle and a controller in communication with the display. The controller determines when the vehicle is in motion. The controller prohibits display of video information by the display when the vehicle is in motion and stores the video information that is not being displayed. The controller permits display of the stored video information when the vehicle is not in motion. A method of video display in a vehicle is also provided. The method includes determining when a vehicle is in motion, prohibiting display of video information when the vehicle is in motion, storing the video information that is not being displayed, and permitting display of the video information that was stored, by an operator of the vehicle when the vehicle is not in motion.

### BACKGROUND OF THE INVENTION

1. Field of the Invention

This invention relates to a vehicle video display system, and particularly to a display system where video and audio information are spooled or stored based on certain conditions of the vehicle.

2. Description of Background

Before our invention automotive DVD players have been found in the back of headrests and mounted from the roof of vehicles. Satellite television is also available, with the video displays found in the same locations. These video displays are typically positioned for viewing from the rear seats of the vehicles. There are also after market in-dash DVD players, where the video display slides out from the device and pivots upwardly for viewing. These in-dash DVD devices are viewable by the operator of the vehicle. However, the in-dash DVD devices are configured to prevent video viewing unless the vehicle is parked.

Several states have laws prohibiting a video display for entertainment purposes that is positioned to be viewable by an operator. Other states further prohibit locating a video display forward of the back of an operator's seat. In general these states provide exemptions for vehicle navigational displays and the like. However, other states have not enacted laws regarding positioning of video displays that are viewable by the operator.

### SUMMARY OF THE INVENTION

The shortcomings of the prior art are overcome and additional advantages are provided through the provision of a video display system for use in a vehicle. The vehicle display system includes a display disposed in a vehicle for viewing by an operator of the vehicle and a controller in communication with the display. The controller determines when the vehicle is in motion. The controller includes a storage device. The controller prohibits display of video information by the display when the vehicle is in motion and stores the video information that is not being displayed at the storage device. The controller permits display of the video information at the storage device when the vehicle is not in motion.

A method of video display in a vehicle is also provided. The method includes determining when a vehicle is in motion, prohibiting display of video information when the vehicle is in motion, storing the video information that is not being displayed, and permitting display of the video information that was stored, by an operator of the vehicle when the vehicle is not in motion.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

As a result of the summarized invention, technically we have achieved a solution which allows video viewing by an operator when a vehicle is not in motion and which spools/stores broadcast video when the vehicle is in motion so that viewing can be resumed uninterrupted when the vehicle is again no longer in motion.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of transparent organic light-emitting devices mounted at a windshield of a vehicle to provide a display for the operator of the vehicle; and

FIG. 2 illustrates one example of a flow chart for spooling /storing the

The detailed description explains the preferred embodiments of the invention, together with advantages and features, by way of example with reference to the drawings.

### DETAILED DESCRIPTION OF THE INVENTION

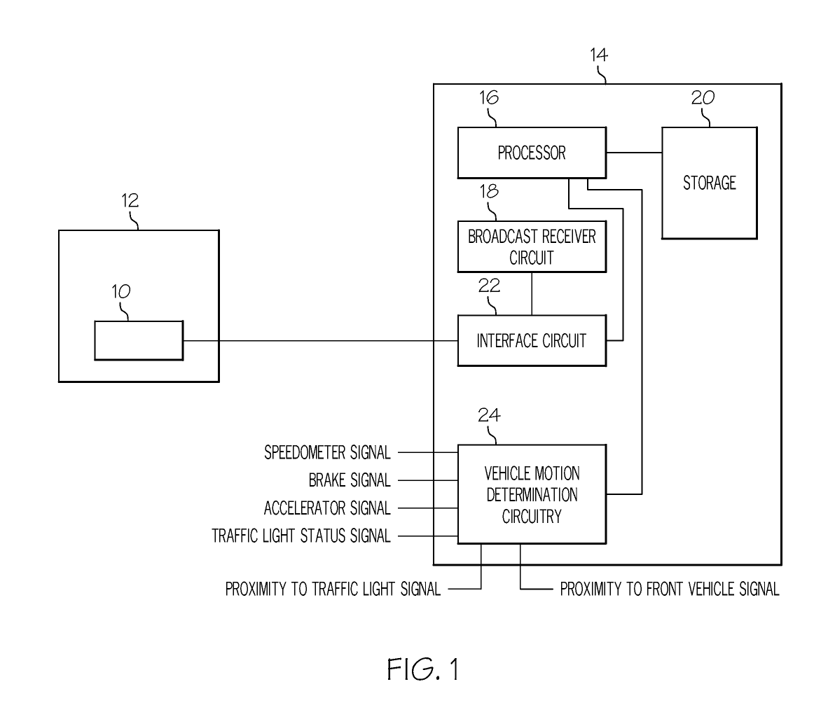

Turning now to the drawings in greater detail, it will be seen that in FIG. 1 there is a transparent organic light-emitting device (TOLED) 10 mounted at a front window glass (windshield) 12 of an automobile (not shown). Transparent organic light-emitting devices are known, and are comprised of a conventional organic light-emitting device that has a transparent compound cathode. TOLEDs are 70% to 85% transparent when switched off, which is nearly as clear as glass or plastic. Accordingly, TOLEDs may be suitable to be located on an automotive windshield. TOLEDs are commercially available from, for example, Universal Display Corporation. TOLEDs are well suited for displaying video due to the high-resolution of such active-matrix organic light-emitting devices. The video that could be displayed includes, video news, events, entertainment, and other information, whether stored or a live broadcast. The video also includes an associated audio. The TOLED 10 is electrically connected to a control circuit 14 disposed within the vehicle. The circuit 14 includes a processor circuit 16, a broadcast receiver circuit 18, a storage device 20, an interface circuit 22 (which drives the TOLED 10), and vehicle motion determination circuitry 24. The vehicle motion determination circuitry utilizes a speedometer signal, a signal indicative of an operator releasing a break and/or engaging an accelerator, and/or a signal indicative of the status of a traffic light.

Regarding, the status of an upcoming traffic light, such can be detected by, for example, a smart traffic system such as described in U.S. Pat. No. 6,989,766 to Mese et al., assigned to International Business Machines Corporation, which is incorporated herein in its entirety by reference. The Mese et al. system is a GPS based system that allows a vehicle to receive information regarding the distance and status of an upcoming traffic light. If the speedometer signal is other than 0 M.P.H., the break is released, or the accelerator is engaged the vehicle is in motion. If an upcoming traffic light is red (or yellow) such that the vehicle will be stopping, then the vehicle may be treated as not in motion when the other factors indicate such, thereby allowing the video to play as discussed below. If an upcoming traffic light is green such that the vehicle will not be stopping, then the vehicle will treated as if it were in motion unless the other factors indicate otherwise. For example, if the vehicle were pulled-off to the side of a road. When a vehicle is stopped at a traffic light and the traffic light is detected as changing to green, the vehicle will treated as if it is in motion even though the other factors may not yet indicate such motion. Also, with such a GPS system the proximity to the traffic light can easily be determined, such that a vehicle that is many vehicles away from the traffic light (due to traffic or construction) would be allowed to watch for an addition amount of time. This is due to the fact that in long traffic lines, there is a time lag before vehicles further back in the line move with respect to when to the traffic light changed. Accordingly, in this situation the traffic light may be green but the vehicle is not moving and the system will treat the vehicle as not in motion for the purpose of operating the video. Further, proximity sensors are available on vehicles, and can be used to provide additional information for the system in conjunction with the traffic light detection. More specifically, the video could be allowed to play until the vehicle in front of the vehicle with the video system begins to move. The proximity sensors could detect movement of the vehicle in front.

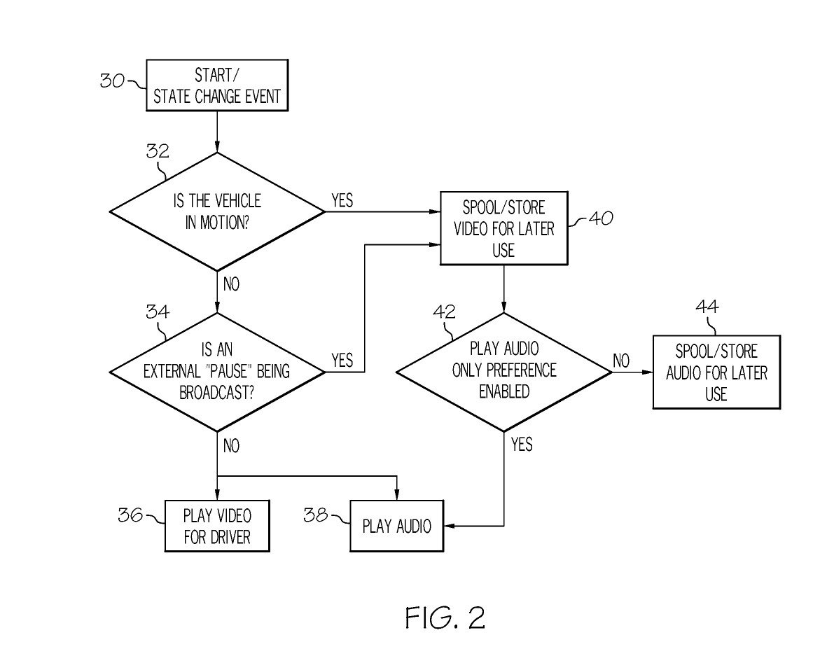

Turning to FIG. 2, a flow diagram for controlling video is shown. In general, control of the video is based on motion of the vehicle and/or proximity to a traffic light. This process is embedded in software, which is run on the processor circuit 16. Alternatively, the software can be stored and run on a computer of the vehicle. The video includes broadcast video, which includes streaming video from satellite or may be terrestrial. A block 30 detects a start/state change event, which is a video that an operator expects to view at an appropriate time. When such a video is ready or available for viewing an inquiry is made to determine if the vehicle is in motion at a block 32, i.e., (Is the vehicle in motion?). If the vehicle is not in motion, then an inquiry is made regarding an overriding pause command at block 34, i.e., (Is an external “pause” being broadcast?). Receiver circuit 18 receives the video. If there is not a pause being broadcast, then the video is played at block 36 by TOLED 10 and the associated audio is played at block 38 by the audio system of the vehicle. Alternatively, a separate audio system may be utilized. Returning to block 32, if the vehicle is in motion, then the video is spooled/stored for later use, at block 40. The video is stored at storage device 20. Also, returning to block 34, if there is a pause broadcasted, then the video is spooled/stored for later use, at block 40. The audio is also stored with the associated video. Even though the audio is being stored an option is provided at block 42 to enable the audio while the broadcast is being stored (block 40). If this audio feature is enabled the audio is played at block 38 by the audio system of the vehicle. If the audio feature is not enabled, then the audio separately can be spooled/stored for later use individually, at block 44. It will be appreciated that the audio is stored with the video at block 40, regardless of whether or not the audio preference is enabled.

The spooled/stored images and audio may be accessed at any time permitted by the system, i.e., when the vehicle is not in motion. Further, the playback rate may be accelerated to allow the operated to catch up on live broadcast.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A video display system for use in a vehicle, comprising:
a display disposed in a vehicle for viewing by an operator of the vehicle; and
a controller disposed in the vehicle and in communication with the display, the controller determining when the vehicle is in motion, the controller including a storage device, the controller prohibiting display of video information by the display when the vehicle is in motion and storing the video information that is not being displayed at the storage device, the controller permitting display of the video information at the storage device when the vehicle is not in motion.

2. The video display system of claim 1 wherein the controller further stores audio information associated with the video information at the storage device.

3. The video display system of claim 1 wherein the controller determining when the vehicle is in motion is in response to at least one of a speedometer signal, a signal indicative of an operator releasing a break of the vehicle, a signal indicative of an operator engaging an accelerator of the vehicle, and a signal indicative a status of a traffic light.

4. The video display system of claim 1 wherein the controller determining when the vehicle is in motion is in response to a signal indicative a status of a traffic light and a signal indicative of a proximity of the vehicle to the traffic light.

5. The video display system of claim 4 wherein the controller determining when the vehicle is in motion is further in response to a signal indicative motion of another vehicle in front of the vehicle.

6. The video display system of claim 1 wherein the video information comprises broadcast video.

7. The video display system of claim 6 wherein the broadcast video comprises streaming video from a satellite or terrestrial.

8. The video display system of claim 1 wherein the display comprises a transparent organic light-emitting device.

9. The video display system of claim 8 wherein the transparent organic light-emitting device is mounted at a windshield of the vehicle for viewing by an operator of the vehicle.

10. A method of video display in a vehicle, comprising:
determining when a vehicle is in motion;
prohibiting display of video information when the vehicle is in motion;
storing the video information that is not being displayed; and
permitting display of the video information that was stored, by an operator of the vehicle when the vehicle is not in motion.

11. The method of video display of claim 10 further comprising:
storing audio information associated with the video information that was stored.

12. The method of video display of claim 10 wherein the determining when the vehicle is in motion comprises at least one of obtaining a speedometer indication, detecting an operator releasing a break of the vehicle, detecting an operator engaging an accelerator of the vehicle, and determining a status of a traffic light.

13. The method of claim 10 wherein the determining when the vehicle is in motion comprises determining a status of a traffic light and determining a proximity of the vehicle to the traffic light.

14. The method of claim 13 wherein the determining when the vehicle is in motion further comprises determining motion of another vehicle in front of the vehicle.

15. The method of video display of claim 10 wherein the video information comprises broadcast video.

16. The method of video display of claim 15 wherein the broadcast video comprises streaming video from a satellite or terrestrial.
